(19) United States
(12) Patent Application Publication
(10) Pub. No.: US 2008/0037078 A1
(43) Pub. Date: Feb. 14, 2008

(54) Scanning device having two scanning heads for scanning alternately and copy apparatus using the same

(75) Inventor: Yen-Cheng Chen, Hsin Chu City (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/826,771

(22) Filed: Jul. 18, 2007

(30) Foreign Application Priority Data
Aug. 9, 2006 (TW) 095129133

(51) Int. Cl. H04N 1/04

(52) U.S. Cl. 358/498

(57) ABSTRACT

A scanning device includes an input tray, an input path, an output path, an output tray, a first scanning head, a second scanning head and a sheet-transporting mechanism. The input tray stores a plurality of documents. The input path is connected to the input tray and the output path, and the output tray is connected to the output path. The first scanning head on the input path scans a backside of each document to output a backside image signal. The second scanning head on the output path scans a front side of each document to output a front side image signal. The sheet-transporting mechanism transports each document from the input tray to the output tray sequentially along the input path and the output path. The sheet-transporting mechanism transports each document in the input path in one direction and in the output path in a reverse direction.

### BACKGROUND OF THE INVENTION

1. Field of Invention

The invention relates to a scanning device and a copy apparatus thereof, and more particularly to a scanning device having two scanning heads for alternately scanning a document, and a copy apparatus using the same.

2. Related Art

FIG. 1 is a schematic illustration showing a conventional copy apparatus 100. As shown in FIG. 1, the conventional copy apparatus 100 includes a scanning device 110, a printing processor 120 and a printing device 130. The scanning device 110 and the printing device 130 are electrically connected to the printing processor 120. The scanning device 110 includes two scanning heads 111 and 112 for respectively scanning a front side 113F and a backside 113B of a document 113 moving along a path 115, and thus outputting a front side image signal 114F and a backside image signal 114B to the printing processor 120. The printing processor 120 processes the front side image signal 114F and the backside image signal 114B into a front side printing signal 124F and a backside printing signal 124B to be received by the printing device 130 for printing. The printing device 130 receives the front side printing signal 124F and the backside printing signal 124B to print data on two sides of a sheet 134.

The printing device 130 includes an input tray 131, an output tray 132 and a printing unit 133. In this example, the printing unit 133 is an electrophotographic device. The sheet 134 stored in the input tray 131 is outputted to the output tray 132 along paths 135 and 136. In order to keep the sequence order of the sheets intact when the sheets are delivered to the output tray 132, the backside printing signal 124B has to be printed first on a backside 134B of the sheet 134, and then the front side printing signal 124F is to be printed on a front side 134F of the sheet 134. The states of a leading edge 134L, a trailing edge 134R, the front side 134F and the backside 134B of the sheet 134 in the input tray 131 and the output tray 132 are shown in FIG. 1.

Because the printing processor 120 has to store the front side image signal 114F and the backside image signal 114B and to generate the front side printing signal 124F and the backside printing signal 124B, it becomes necessary for the printing processor 120 to be provided with a relatively large buffer. However, with this large memory space the production cost for the copy apparatus 100 increases.

### SUMMARY OF THE INVENTION

It is therefore an object of the invention to provide a scanning device having two scanning heads for alternately scanning a document, wherein the scanning device outputs a backside image signal and a front side image signal in a sequence same as that a duplex printing device outputs the corresponding print data, so as to save the manufacturing cost.

To achieve the above-identified object, the invention provides a scanning device having two scanning heads for alternately scanning a document. The scanning device includes an input tray, an input path, an output path, an output tray, a first scanning head, a second scanning head and a sheet-transporting mechanism. The input tray stores a plurality of documents. The input path is connected to the input tray, the output path is connected to the input path, and the output tray is connected to the output path. The first scanning head disposed on the input path scans a backside of each of the documents to output a backside image signal. The second scanning head disposed on the output path scans a front side of each of the documents to output a front side image signal. The sheet-transporting mechanism transports each of the documents from the input tray to the output tray sequentially through the input path and the output path. The sheet-transporting mechanism transports each of the documents in the input path in one direction and in the output path in a reverse direction. The invention also provides a copy apparatus having two scanning heads for alternately scanning the document.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic illustration showing a conventional copy apparatus.

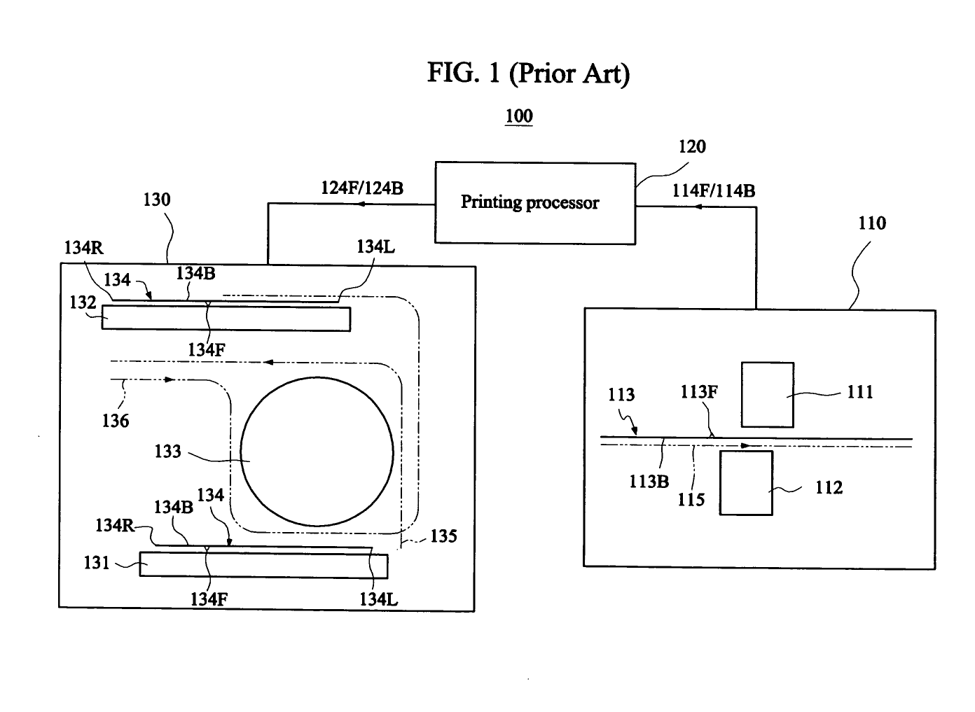

FIG. 2 is a schematic illustration showing a scanning device according to a first embodiment of the invention.

FIG. 3 is a schematic illustration showing a copy apparatus according to a second embodiment of the invention.

### DETAILED DESCRIPTION OF THE INVENTION

The present invention will be apparent from the following detailed description, which proceeds with reference to the accompanying drawings, wherein the same references relate to the same elements.

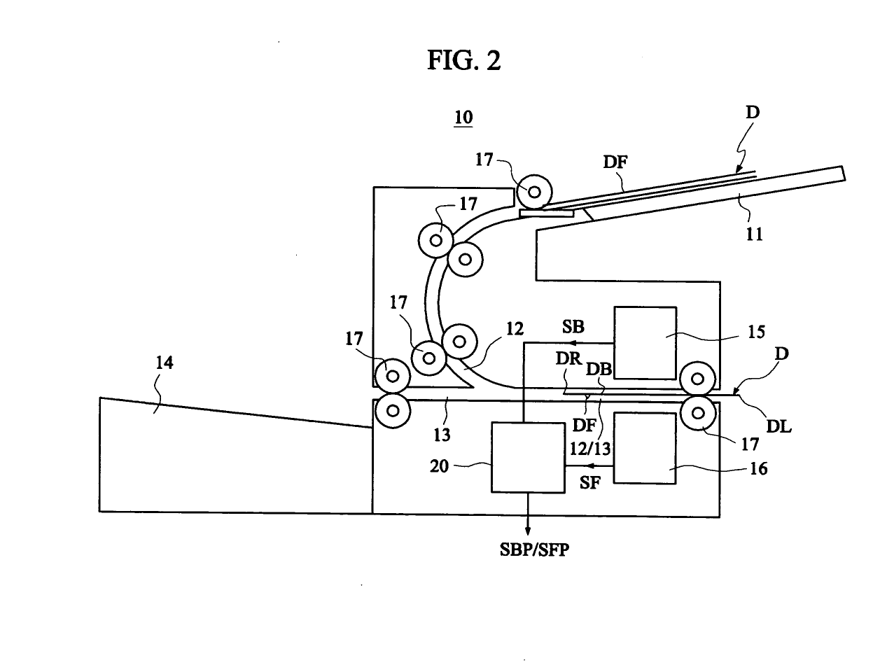

FIG. 2 is a schematic illustration showing a scanning device 10 according to a first embodiment of the invention. Referring to FIG. 2, the scanning device 10 includes an input tray 11, an input path 12, an output path 13, an output tray 14, a first scanning head 15, a second scanning head 16 and a sheet-transporting mechanism 17. The input tray 11 stores a plurality of documents D. A front side DF of the document D faces upwards. The sheet-transporting mechanism 17 transports an uppermost document. The input path 12 is connected to the input tray 11, the output path 13 is connected to the input path 12, and the output tray 14 is connected to the output path 13. The first scanning head 15 disposed on the input path 12 scans a backside DB of each document D to output a backside image signal SB. The second scanning head 16 disposed on the output path 13 scans the front side DF of each document D to output a front side image signal SF. In this embodiment, the input path 12 partially overlaps the output path 13, and the first scanning head 15 faces the second scanning head 16. However, the invention is not particularly limited thereto. That is, the input path 12 may not overlap the output path 13, or the first scanning head 15 may not face the second scanning head 16.

The sheet-transporting mechanism 17 includes a plurality of rollers for transporting each document D from the input tray 11 to the output tray 14 sequentially through the input path 12 and the output path 13. After the backside DB of the document D has been scanned by the first scanning head 15, the sheet-transporting mechanism 17 reverses to transport the document D back so that the front side DF of the document can be scanned. Thus, the sheet-transporting mechanism 17 transports each document D in the input path 12 in one direction and in the output path 13 in a reverse direction. In this case, the first scanning head 15 scans the backside DB from a leading edge DL to a trailing edge DR of the document D, and the second scanning head 16 scans the front side DF from the trailing edge DR to the leading edge DL of the document D.

In order to duplicate the images of the document D, the scanning device 10 of this embodiment may further include or operate in cooperation with a printing processor 20 for sequentially receiving and processing the backside image signal SB and the front side image signal SF into a backside printing signal SBP and a front side printing signal SFP to be received by a printing device for printing. Thus, the scanning device 10 of this embodiment may be directly connected to a printer and the duplex copy operation can be carried out. It is to be noted that the printing processor 20 does not necessary to be included in the scanning device 10, and that the printing processor 20 may also be a computer.

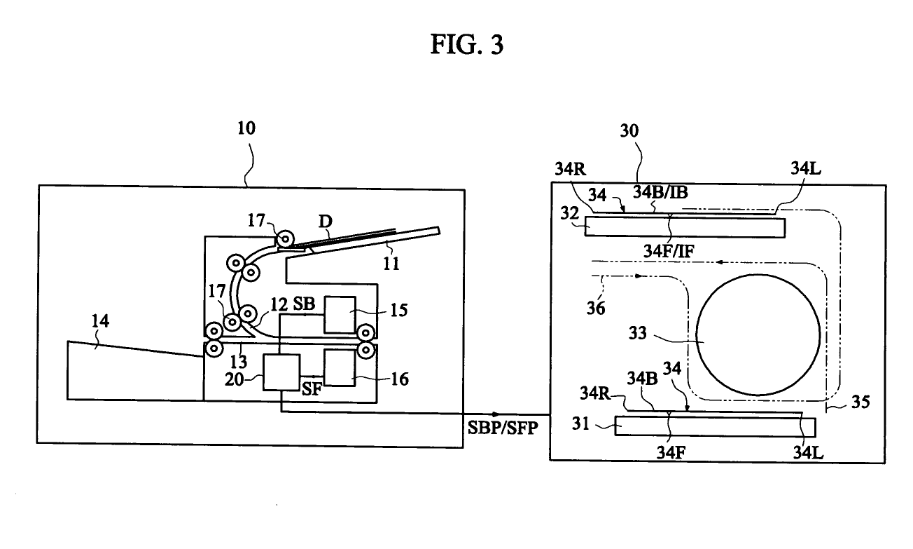

FIG. 3 is a schematic illustration showing a copy apparatus according to a second embodiment of the invention. Referring to FIG. 3, the copy apparatus of this embodiment includes a scanning device 10, a printing processor 20 and a printing device 30. The members and the operation methods of the scanning device 10 have been described in the first embodiment, so detailed descriptions thereof will be omitted. The printing processor 20 may be built in the scanning device 10 or the printing device 30 or may be independent from the scanning device 10 and the printing device 30.

The printing device 30 includes an input tray 31, an output tray 32 and a printing unit 33. In this example, the printing unit 33 is an electrophotographic device. A print medium 34 stored in the input tray 31 is outputted to the output tray 32 along paths 35 and 36 when the duplex printing is being carried out. The states of a leading edge 34L, a trailing edge 34R, a front side 34F and a backside 34B of the print medium 34 when stored in the input tray 31 and in the output tray 32 are shown in FIG. 3. The printing device 30 sequentially prints a backside image IB corresponding to the backside printing signal SBP on the backside 34B of the print medium and a front side image IF corresponding to the front side printing signal SFP on the front side 34F of the print medium 34. The print medium 34 may be a sheet of paper. The backside image IB and the front side image IF respectively correspond to the images of the backside DB and the front side DF of the document D. In this case, the printing processor does not have to store the front side image signal and the backside image signal simultaneously. Thus, it is unnecessary to provide a relatively large buffer space for the generation of the front side printing signal and the backside printing signal. The cost of the copy apparatus can thus be effectively reduced.

In addition, the printing unit 33 may be the electrophotographic device as mentioned hereinabove, or an ink-jet printer.

According to the embodiments of the invention, two scanning heads scan each side of the documents alternately but not simultaneously. The scan signal obtained by the scanning device can be directly transferred to the printing processor for processing, and then the processed result can be directly outputted by the printing device, while the documents, after being scanned, are stacked in the output tray in the same order as the order in which the documents are originally being stacked in the input tray. Furthermore, the memory capacities required by the scanning device, the printing device and the printing processor may be greatly reduced, and the product cost can be reduced.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A scanning device, comprising:
an input tray for storing a plurality of documents;
an input path connected to the input tray;
an output path connected to the input path;
an output tray connected to the output path;
a first scanning head, disposed on the input path, for scanning a backside of each of the documents to output a backside image signal;
a second scanning head, disposed on the output path, for scanning a front side of each of the documents to output a front side image signal; and
a sheet-transporting mechanism for transporting each of the documents from the input tray to the output tray sequentially through the input path and the output path, wherein the sheet-transporting mechanism transports each of the documents in the input path in one direction and in the output path in a reverse direction.

2. The scanning device according to claim 1, wherein the input path partially overlaps the output path.

3. The scanning device according to claim 1, wherein the first scanning head faces the second scanning head.

4. The scanning device according to claim 1, wherein the first scanning head scans the backside of the document from a leading edge of the document to a trailing edge of the document, and the second scanning head scans the front side of the document from the trailing edge to the leading edge.

5. The scanning device according to claim 1, further comprising:
a printing processor for sequentially receiving and processing the backside image signal and the front side image signal into a backside printing signal and a front side printing signal to be transferred to a printing device for printing.

6. A copy apparatus, comprising:
a scanning device, which comprises:
an input tray for storing a plurality of documents;
an input path connected to the input tray;
an output path connected to the input path;
an output tray connected to the output path;
a first scanning head, disposed on the input path, for scanning a backside of each of the documents to output a backside image signal;
a second scanning head, disposed on the output path, for scanning a front side of each of the documents to output a front side image signal; and
a sheet-transporting mechanism for transporting each of the documents from the input tray to the output tray sequentially through the input path and the output path, wherein the sheet-transporting mechanism transports each of the documents in the input path in one direction and in the output path in a reverse direction;
a printing processor for sequentially receiving and processing the backside image signal and the front side image signal into a backside printing signal and a front side printing signal; and
a printing device for sequentially printing a backside image and a front side image on a backside and a front side of a print medium according to the backside printing signal and the front side printing signal, wherein the backside image and the front side image respectively correspond to images of the backside and the front side of the document.

7. The copy apparatus according to claim 6, wherein the input path partially overlaps the output path.

8. The copy apparatus according to claim 6, wherein the first scanning head faces the second scanning head.

9. The copy apparatus according to claim 6, wherein the first scanning head scans the backside of the document from a leading edge of the document to a trailing edge of the document, and the second scanning head scans the front side of the document from the trailing edge to the leading edge.
